(19) United States
(12) Patent Application Publication
(10) Pub. No.: US 2013/0200164 A1
(43) Pub. Date: Aug. 8, 2013

(54) TRANSPONDER

(71) Applicant: Karl-Heinz Wendisch, Salzkotten (DE)

(72) Inventor: Karl-Heinz Wendisch, Salzkotten (DE)

(21) Appl. No.: 13/816,018

(22) PCT Filed: Dec. 7, 2010
(86) PCT No.: PCT/DE2010/001419

§ 371 Date: Apr. 18, 2013

(30) Foreign Application Priority Data
Aug. 11, 2010 (DE) 20 2010 011 285.0

(51) Int. Cl. G06K 19/077

(52) U.S. Cl. CPC G06K 19/07794
USPC 235/492

(57) ABSTRACT

A transponder comprising a substrate that has an IC module and an antenna in order to form a circuit and comprising another antenna that is operatively connected to the antenna of the substrate. The other antenna is designed as a tubular body, and the antenna of the substrate is disposed within the other antenna.

The invention relates to a transponder according to the preamble of claim 1

The development of the radio-based identification of objects through the use of RFID technology (Radio Frequency Identification) is characterized by the desire to so construct the system component that will be attached to the object, and is referred to as a transponder, such that, with a minimum of effort, greatest possible range can be achieved. Older systems use a low-frequency range of a few kHz (e.g. 125 kHz) to a few MHz (13.56 MHz). Due to the large wavelength, these systems communicatively connect the reading station and a transponder via a magnetic field. The range is accordingly correspondingly low.

A significant increase in range is achieved with the transition to the UHF band (860/915 MHz) or the microwave range (2.4 GHz). Here the wavelength is 30 cm or 12.5 cm. The antennas are correspondingly smaller and the electromagnetic wave broadening is much smaller distances, so that the range will be larger.

Inter alia, from the published patent application DE 11 2008 000 065 T5, the basic structure of a transponder unit, consisting of an IC, which is designed for wireless communication, a power supply circuit substrate on which a power supply circuit is provided, consisting essentially of an inductive conductor loop and possibly a capacitor, with which the two components are connected to form a resonant circuit, and a radiation plate that is substantially magnetically coupled to the resonant circuit. If one constructs such a system, then it becomes clear that the panel is not suitable for various applications. Especially if one just wants to integrate the system into objects, then plate-like structures are not well suited. A simple integration example in wooden pallets allows the design in the form of a nail. Here the use of the 125 kHz technology is very common. As an example, products made by OPAL Associates Holding AG, Wetzikon (CH) can be mentioned. Transponders of this type have, because of the operating frequency, only a short range.

It is an object of the present invention to further develop a transponder in such a way that it, while utilizing the advantages of a high monitoring range of a UHF technique, has a compact design.

To achieve this object, the transponder has the features of claim 1.

The particular advantage of the invention consists in that the transponder has a compact structure. The outer shape of the transponder is characterized by the tubular shape of an antenna circuit surrounding a transponder. The transponder has a very simple design and allows for easy installation and integration with other components. Since the IC module and the antenna transponder circuit are disposed within the tubular antenna, the transponder circuit is protected from mechanical loads.

Further advantages of the invention will emerge from the further subclaims.

Exemplary embodiments of the invention are explained in more detail with reference to the drawings.

Shown are:

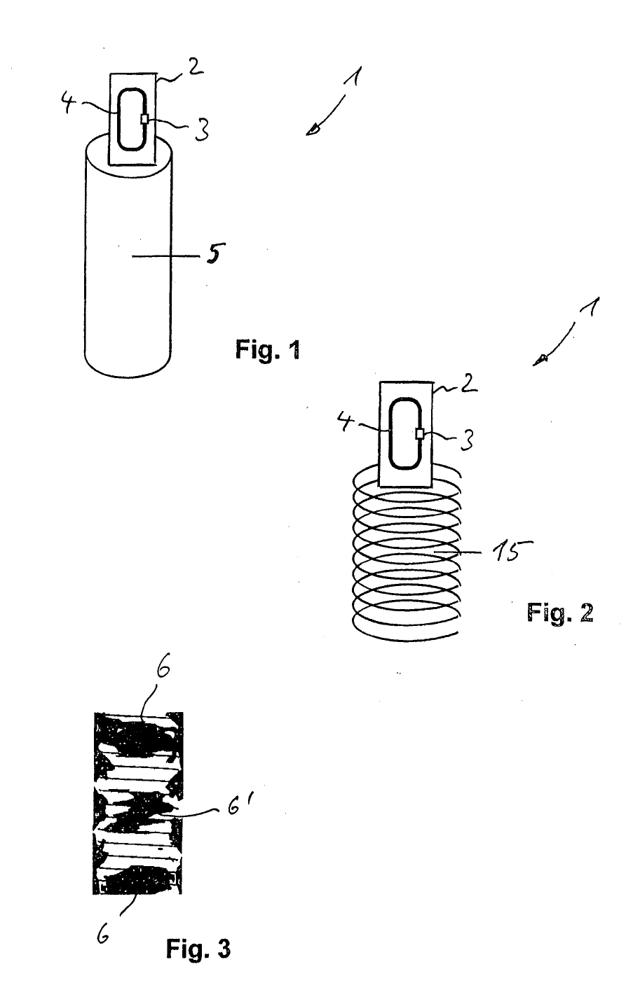

FIG. 1 shows an exploded view of a transponder according to a first embodiment,

FIG. 2 shows an exploded view of the transponder according to a second embodiment, and

FIG. 3 shows a schematic representation of a magnetic flux density distribution in an interior of the second helical antenna of the transponder according to the second embodiment.

A transponder 1 is composed, on the one hand, of a circuit (transponder circuit) with a circuit substrate 2, which has an IC module 3 and a first antenna 4. The circuit substrate 2 can for example be designed as rigid or a flexible printed circuit board. The IC module 3 is designed as a chip, which is electrically connected to the first antenna 4. The IC component 3 and/or the first antenna 4 may be provided on the circuit board 2 by printing or the like.

On the other hand, the transponder 1 has a further antenna, which is formed as a tubular body 5.

For assembly of the transponder 1, the circuit substrate 2 is inserted into an interior of the tubular body 5 or otherwise introduced. The circuit substrate 2 is preferably positioned in regions 6, 6′ of the tubular body 5, in which a relatively high magnetic flux density forms, see FIG. 3. In the present embodiment, the circuit substrate or carrier would be positioned in the areas near to the ends 6 or in the middle 6′. Since the magnetic flux density in the central area 6′ is the greatest, the circuit substrate 2 is positioned preferably with its antenna 4 in the center of the tubular body 5. If the transponder 1 is placed in an electromagnetic field of a reading device, the tubular body serves as a radiator of the RF signal transmitted to the first antenna 4, wherein by the magnetic coupling between the first antenna 4 and the tubular body 5 the high-frequency signal in the UHF range (868 MHz) can be received by the antenna 4 of the circuit substrate 2. The antenna 4 of the circuit substrate 2 is tuned to the operating frequency of 860 MHz to 915 MHz. Here, the antenna 4, together with the capacitively acting IC module 3, is a resonant circuit, so that the high frequency signal can be coupled to the antenna 4.

The tubular body 5 can be formed according to FIG. 1 as a hollow cylinder in a first embodiment, consisting of a metal material. When the circuit substrate 2 is formed flexible, a diameter of the hollow cylindrical body 5 may be smaller than a length or width of the second circuit substrate. The circuit substrate 2 is then preferably bent to form a roll in the state inserted into the cavity of the hollow cylinder 5 and preferably positioned in the central portion 6′.

According to a second embodiment of the transponder 1 in accordance with FIG. 2 the tubular body may be formed as a helical body 15, which consists of a spirally or helically twisted, wound round wire material, preferably made of steel. The coil body 15 can have the same dimension as the hollow cylindrical body 5 Advantageously, during assembly of the transponder 1, by changing the distance between the turns and/or the diameter of the same place a tuning of the thus formed second antenna 15 to the resonant frequency of the circuit substrate 2 can take place.

The coil body 15 can be wound from a spring wire (circular wire). Alternatively, it can also be wound from flat metal strip (rectangular in cross-section). Advantageously, the spiral body 15 may be integrated within flexible further materials or components. For example, the transponder 1 with the body 15 of the spiral can be injected or cast into a body of a component made of elastic or plastic solid. Thereby pins, nails or screws, in which the transponder functionality is incorporated, can be produced.

Preferably, the circuit substrate 2 is operated in a resonance.

The same components and component functions of the embodiments are provided with the same reference numerals.

According to a non-illustrated further embodiment of the invention, the tubular body 5 may be provided with one or more transverse slots.

According to yet a further non-illustrated embodiment of the invention, the tubular body together with the circuit can form a cast part with a circular or four-sided quadrilateral cross-section, said outer walls of the cast part may be smooth or provided with braces or flanges such that the cast part can be used as an anchor for anchoring in a wall. The cast part consists of a plastic material and may have the diameter of a standardized series with an externally applied screw thread.

The coil body comprises, at at least one end, wire ends, which extend in the axial and/or radial direction. These wire ends allow a better coupling.

1. A transponder with a circuit substrate having an IC chip and an antenna for forming a circuit, and with another antenna operatively connected to the antenna of the circuit substrate, wherein the additional antenna (5, 15) is in the form of a tubular body (5, 15) and that the antenna (4) of the circuit substrate (2) is arranged within the additional antenna (5, 15).

2. The transponder according to claim 1, wherein the tubular body (5, 15) is provided with one or more transverse slots.

3. The transponder according to claim 1, wherein the circuit substrate is formed from a flexible insulating material such that it can be introduced into the tubular body (5, 15) by bending or rolling up.

4. The transponder according to claim 1, wherein the circuit substrate (2) is formed as a rigid printed circuit board.

5. The transponder according to claim 1, wherein the tubular body is formed as a spiral body (15) with a spirally wound wire or flat metal strip.

6. The transponder according to claim 1, wherein a length of the spiral body (15) is chosen so that it corresponds to half the wavelength of the operating frequency of the circuit or to a multiple of half the wavelength.

7. The transponder according to claim 1, wherein the spiral wound body (15) consists of a wound spring wire.

8. The transponder according to claim 1, wherein the circuit substrate (2) is connected to the tubular body (5, 15) by casting or injection molding an insulating material.

9. The transponder according to claim 1, wherein the tubular body (5, 15) together with the circuit forms a cast part with a round or quadrilateral cross-section, said outer walls of the cast part provided smooth or projections such that the cast part can be used as an anchor.

10. The transponder according claim 1, wherein the cast part consists of a plastic material and has the diameter of a standard series screw with an externally applied thread.

11. The transponder according to claim 1, wherein the casting material consists of an elastic casting material.

12. The transponder according to claim 1, wherein at least one end of the spiral body (15) has wire ends which extend in the axial and/or radial direction.
